(19) United States
(12) Patent Application Publication
(10) Pub. No.: US 2005/0197943 A1
(43) Pub. Date: Sep. 8, 2005

(54) Risk reduction associated with art dealers and dealers in other commodities

(76) Inventors: Dan Galai, Jerusalem (IL); Mordokhi Shniberg, Elkana (IL)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 11/040,322

(22) Filed: Jan. 20, 2005

Related U.S. Application Data
(60) Provisional application No. 60/537,958, filed on Jan. 21, 2004.

(51) Int. Cl. G06F 17/60

(52) U.S. Cl. 705/35

(57) ABSTRACT

A partnership between financial investors and dealers helps mitigate the risk associated with investing in commodities, such as emerging art, while allowing the dealers in the works of art to participate in the future appreciation of the artworks they sell. Investors invest money in a fund in exchange for financial instruments that entitle them to shares of the fund revenues. The fund acquires works of art from art dealers, who forego at least a portion of their profit from the immediate sale of the asset in return for a financial instrument that entitles them to a share of the funds revenues. Revenues are generated on behalf of the fund through commercialization of the works of art in the fund. Investors and dealers are entitled to a share of the revenues according to the terms of the financial instruments they receive. Because the dealers forego a portion of the their commission, the model can create an internal leverage by leveraging investors' money to but more works of art than otherwise would be possible. Both investors and dealers can profit from the future appreciation in value of the works of art (or other assets) as they are commercialized by the fund.

### CROSS-REFERENCE TO RELATED APPLICATION(S)

This application claims the benefit of priority of U.S. Provisional Patent Application No. 60/537,958, filed on Jan. 21, 2004. The disclosure of that application is incorporated by reference herein.

### BACKGROUND

The present disclosure generally relates to financial engineering, and specifically to the reduction of risk related to the investment in works of art and other commodities.

The art business in general and the visual art business in particular are proving to be an economically sound, high-profit business even in tense economic climates. Lead by individual and corporate investors, auction houses, collectors, Wall Street cash funds and art dealers, investment in works of visual art has maintained above-average returns and is recognized as a high-performance investment. As such, it has attracted new types of investors, such as commercial corporations (albeit preferential tax treatment and non-disclosure regulations can also be recognized as a contributing factor).

Investing in emerging art has the potential for great returns. However, it is viewed as risky because the artworks and artists are new to the market and do not have a long track record. At the same time, talented young art dealers often are unable to participate in the future appreciation of the artists they represent because they cannot afford to purchase these artists' works of art. The present disclosure attempts to address those issues. It provides a mechanism to mitigate the risk associated with investing in emerging art (or other commodities) while allowing the dealers to participate in the future appreciation of works by artists they represent.

### SUMMARY

The present disclosure relates to a model for a partnership between financial investors and dealers that can help reduce the risk to investors and allow the dealers to substitute immediate income for long-term capital gain. A fund acquires the assets (e.g., works of art), for example, by purchasing them from the dealers who forego at least part of their immediate compensation (e.g., profit from the sale of the asset) in return for partnership shares in the fund. Investors' money may be used to cover the net-cost (not including dealer's share) of the assets. Both investors and dealers can profit from the future appreciation in value of the assets. The model creates an internal-leverage, so that investors' financial investment can be leveraged without increasing the risk-involved with standard leveraging through the borrowing of funds.

For purposes of illustration, visual artworks are used as the relevant commodity. However, the techniques described below may be applied to other types of artworks as well as to other commodities in various markets in which intermediaries may be involved in the purchase of the commodities. Examples of other commodities to which the techniques may be applied include, but are not limited to, precious stones and collectibles, as well as real estate property.

As explained in greater detail below, according to one implementation, individual art dealers may be selected to participate in a fund. Works of art that are identified by the art dealers may be accepted into a pool of artworks owned and managed by the fund. In exchange for each work of art identified by a particular dealer and accepted into the fund, the art dealer receives one or more financial instruments based, for example, on the current value of the work of art. The artworks may be commercialized by the fund, for example, through sales of the artworks. Each dealer receives a percentage of the future income stream based on the financial instruments she holds.

Based on the type of financial instrument, dealers may receive various benefits. One such possible benefit for art dealers is risk diversification through the pooling of artworks identified by multiple dealers over a period of time. In one particular scenario, a dealer, in exchange for foregoing receipt of immediate compensation, receives a future share of the fund's revenues from the sale of the pool of works of art purchased by the fund. Another benefit can be bonus payments for dealers whose works achieve exceptional returns.

A particular example is described below. The description includes a detailed example of the fund's operation, including allocation of the liquidation value of the artworks sold by the fund. In addition, an example of a time-table for the selection and purchase of the artworks and liquidation of the fund is provided.

As explained below, in some cases, upon acceptance of the work of art into the fund, the fund may pay a fixed percentage (e.g., 50 percent) of the value of the artwork to the art dealer who may use the funds to pay the artist. In other cases, the fund may pay a fixed percentage of the value of the artwork to the art dealer who would have the option of dividing those funds between herself and the artist. In such cases, the art dealer and the artist may share in the income stream obtained from the future commercialization of the artworks by the fund.

A computer system with one or more databases may be provided to calculate and distribute revenues to the art dealers and investors. The databases may store, for example, various information related to the calculation and distribution of revenues.

Other features and advantages will be readily apparent from the following detailed description, the accompanying drawings, and the claims.

### BRIEF DESCRIPTION OF THE DRAWINGS

FIG. 1 illustrates an example of the structure of an enterprise through which investors may enjoy lower risk by partnering with dealers, who in turn share in the future revenues from the sale of the artworks.

FIG. 2 is a flow chart illustrating an example of the operation of the enterprise.

FIG. 3 illustrates an example of an allocation of proceeds to the partners in the fund.

FIG. 4 illustrates a timeline for a particular implementation of a fund's operations.

FIG. 5 illustrates an example of a system for the disbursement of revenues to which investors and dealers are entitled.

### DETAILED DESCRIPTION OF PREFERRED EMBODIMENTS

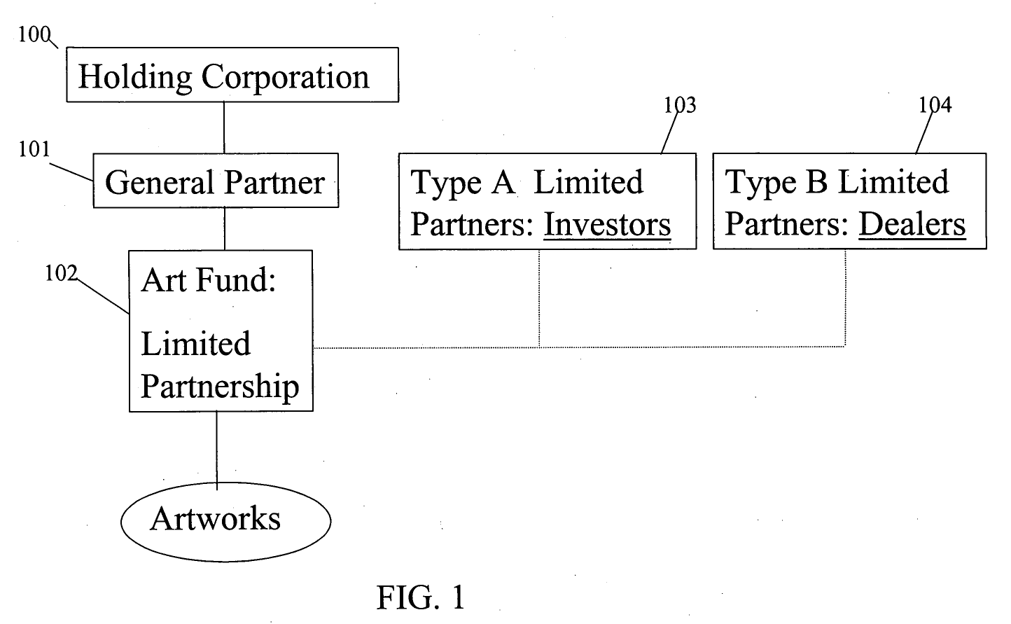

FIG. 1 illustrates an example of the structure of an enterprise through which a partnership is created between investors and dealers (e.g., brokers and traders) to reduce investors' risk and allow dealers to participate in the appreciation of assets they sell to the partnership. In this example, the assets are works of art. In this disclosure, the phrases “works of art” and “artworks” include, but are not limited to, visual arts including paintings, sculptures, photographs, videos, films and collectibles.

As shown in FIG. 1, the enterprise may include (a) a fund, such as a limited partnership 102 with different classes of partners (e.g., investors 103 and dealers 104), (b) a general partner 101, and (c) a holding corporation 100.

In this example, investors invest in the limited partnership 102, providing funding for the purchase of artworks. The general partner 101 selects the works of art to be purchased. Once the general partner 101 selects a work of art for purchase, the general partner and the dealer of the selected work enter into an agreement pursuant to which the dealer agrees to sell the work to the fund (i.e., the limited partnership 102). The dealer may be paid a certain percentage (e.g., 50%) of the agreed market value of the work of art in cash or other forms of money equivalents. The dealer would forego the remainder of the market value in return for a financial instrument which provides the dealer with participation in the revenues of the fund from the sale of the commodities, in this example, works of art.

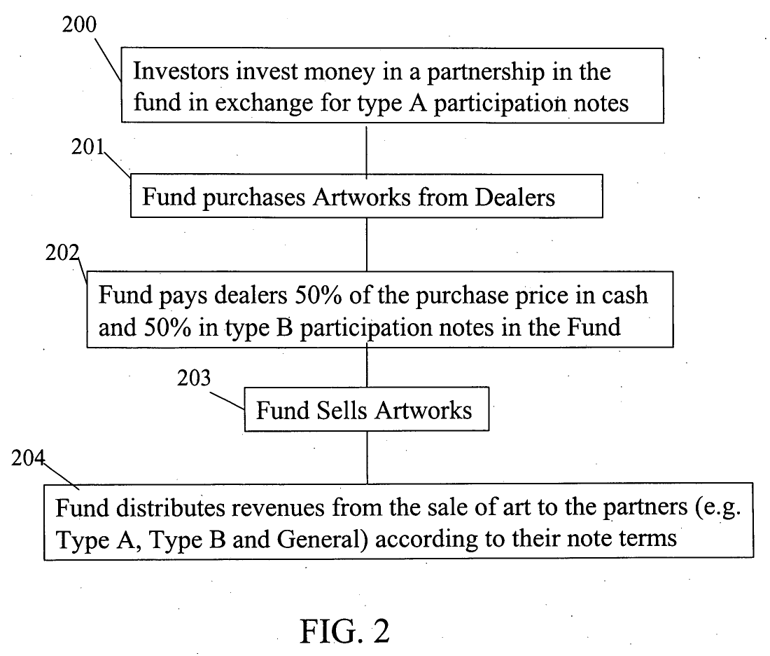

FIG. 2 is a flow chart to illustrate a method that allows investors to invest in art in a manner that increases the diversification of their investment while reducing the risk of investing in emerging art and allows dealers to participate in the fund's appreciation.

Initially, the legal entities are created, teams of professionals are recruited, and operational guidelines are implemented. Investors agree to invest a predetermined amount in the fund (block 200).

Preferably, the general partner 101 selects works of art in which to invest the fund's monetary assets according to predetermined guidelines.

The fund purchases the works from the art dealers for an agreed price of which, for example, fifty-percent is paid in cash or other currency. The remaining fifty-percent is foregone in exchange for a financial instrument (e.g., type B participation notes in the fund) (block 201).

The works of art may be commercialized, for example, by selling them through various venues (e.g., the dealers from which they were purchased, auction houses, directly by the general partner to collectors, or museums) (block 203). Once works of art are sold, the revenues may be distributed (block 204).

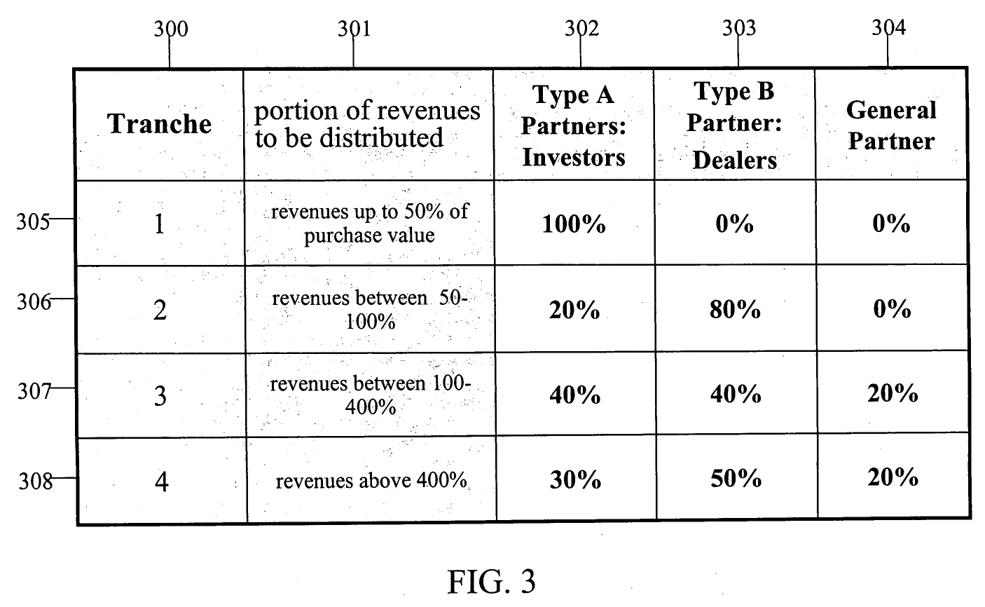

FIG. 3 illustrates a chart of a possible allocation of revenues from the sale of the art purchased by the fund between the different classes of partners for the situation in which the model is structured as a partnership and the financial instruments provided to the investors and dealers are partnership shares.

The tranches column 300 signifies a level of revenues from the sale of artworks. Column 301 indicates what range of proceeds each tranche refers to. Column 302 shows the percentage of revenues allocated to the investors from the revenues associated with the relevant tranche based on the financial instruments(s) they received in exchange for their financial investments(). Column 303 shows the percentage of revenues allocated to the dealers from the revenues associated with the relevant tranche for the financial instruments they received in exchange for foregoing a portion of their commission on the sale of the works of art to the fund. Column 304 shows the percentage of revenues allocated to the general partner for the services it provides to the limited partnership from the revenues associated with the relevant tranche.

Tranche 1, row 305 shows the allocation of all revenues from the sale of works up to fifty-percent of the purchase price of the purchase value of the assets purchased (of which 50% was paid in cash to the dealers). Row 306 shows the allocation of revenues from the sale of works, from 50% to 100% of the original purchase value. Row 307 shows the allocation of revenues from 100% to 400% of original purchase value. Row 308 shows the allocation of all revenues achieved above 400% of the original purchase value.

The chart shows that, for this example, all revenues associated with tranche 1 (row 305), up to fifty-percent of original purchase value, are distributed to the investors. That feature can provide investors protection against a decline in-value of the artworks. For example, even if the original value of the purchased art drops by fifty-percent, investors will receive their complete invested principal because they receive all revenues from the sale of the art up to fifty-percent of the original purchase value, corresponding to the amount they invested.

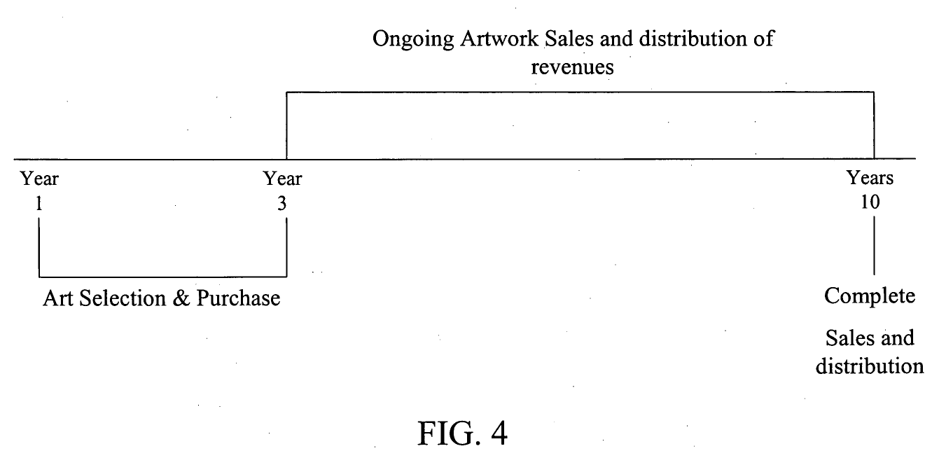

FIG. 4 illustrates a specific example in which the lifetime of the fund is set to ten years. In this particular example, the fund starts to operate after raising funds from investors. Once it is operating, art is selected and purchased-over the course of three years. Art is sold, starting at year three, for seven years.

In a particular example, the financial instruments given to the investors in exchange for their financial investment are shares in a limited partnership. The shares entitle the investors with a certain defined share of the revenues of the partnership. The financial instruments given to the dealers can be shares in the limited partnership that entitle the dealers with a certain defined share of the revenues of the partnership. Those shares may entitle the dealer to a share of the revenues based on various criteria, such as the amount of commission foregone upon sale of artworks to the fund, the appreciation in the value of the work of art while in the fund's possession, the appreciation of the works of art sold to the fund by one dealer compared with the appreciation of the works of art sold to the fund by other dealers.

A computer system with one or more databases may be provided to calculate and distribute revenues to the art dealers and investors.

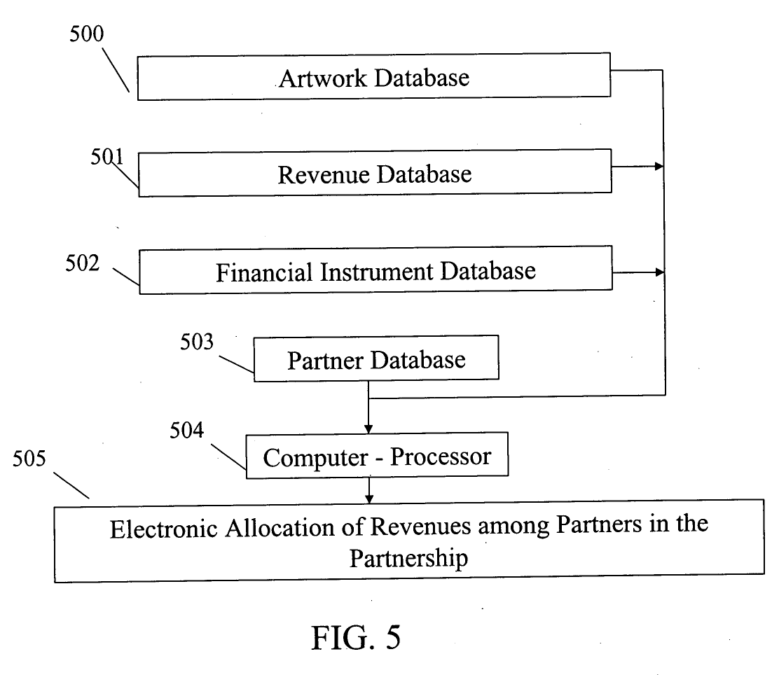

As shown in FIG. 5, the system may include an artwork database 500 to store information regarding each work of art purchased by the fund. The stored information may include (a) the title of the artwork; (b) the name of the artist; (c) the name of the dealer from which the work was purchased (d) the appraisal value of the artwork; (e) the date of purchase of the artwork; (f) the type of artwork; (9) purchase price; and (h) an index code for the artwork. Other information also may be stored in the database 500.

The system also may include a second revenues database 501 to store information regarding the revenues derived from the commercialization of each work of art. The information may include (a) an index code for each artwork; (b) the techniques used to commercialize each artwork to produce revenue; (c) the amount of revenues obtained from commercializing each artwork; and (d) costs and expenses incurred in commercializing each artwork.

The system may include a third financial instrument database 502 to store detailed information regarding the types of financial instruments held by the partners (investors, dealers, general partner) in the partnership and the rights each financial instrument confers upon its holder. A fourth participant database 503 may store information for each partner in the partnership, as well as the number and type of financial instruments to which he is entitled.

The various databases 500, 501, 502, 503 may be provided either as separate databases or a single database. Therefore, references to first, second, third and fourth databases are for convenience only and may, in some implementations, comprise a single database that stores the relevant information.

A machine, such as a computer system including a processor 504, is coupled to the databases 500, 501, 502, 503, and is adapted to calculate the payable portion of each participant based on the number and type of financial instruments in which he has tenure or to which he is entitled. An electronic means 505 is coupled to the computer 504 to cause the disbursement of revenues among the partners in the fund. The electronic means 505 may include, for example, communication links to banks or other financial institutions where the participants have accounts. The electronic means 505 may provide for the automated transfer of funds.

Various modifications may be made to the particular implementations described above without departing from the spirit and scope of the invention. For example, the various numbers identified in the foregoing pages are examples only and may vary in other implementations. Thus, any of the following may differ in other implementations: the number of artists and dealers, the length of various time periods, the percentages used in the initial financing method, the number and type of financial instruments issued to each dealer, and the details regarding how the income stream from the commercialization of the artworks is allocated among the art dealers, investors and the fund itself.

Various aspects of the system may be implemented in hardware, software or a combination of hardware and software. Circuitry, including dedicated or general-purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

Other implementations are within the scope of the claims.

1. A method for reducing risk in connection with dealers in works of art, the method comprising:
accepting works of art to be pooled in a collective investment fund, wherein each work of art is recommended for inclusion in the fund by one of a plurality of art dealers;
issuing one or more financial instruments to each particular art dealer in exchange for one or more works of art recommended by the particular art dealer and accepted by the fund;
generating revenues on behalf of the fund through commercialization of the works of art in the fund; and
distributing a portion of the revenues among the art dealers participating in the fund according to vested interests in the financial instruments held by the art dealers.

2. The method of claim 1 wherein each particular art dealer foregoes at least a portion of immediate income to which that dealer would otherwise be entitled upon acceptance of the one or more works of art by the fund in exchange for receiving the one or more financial instruments.

3. The method of claim 2 further including paying an amount of money to each particular art dealer for the one or more works of art recommended by the particular art dealer and accepted by the fund, wherein the amount of money paid to the particular art dealer is less than market value for the one or more works of art.

4. A method for the reduction of risk in connection with investing in assets, the method comprising:
raising money for a fund from investors in exchange for financial instruments issued to the investors;
purchasing, on behalf of the fund, assets from dealers, wherein each dealer receives a combination of money and one or more financial instruments, wherein each particular dealer foregoes at least a portion of immediate income to which the particular dealer would otherwise be entitled upon sale of the one or more assets to the fund based on market value;
generating revenues on behalf of the fund through commercialization of the assets; and
distributing a portion of the revenues among the dealers and investors according to interests in the financial instruments held by them.

5. The method of claim 4 wherein a particular investor holding one or more of the financial instruments is entitled to receive an amount of the revenues based on the collective commercial success of all the assets commercialized by the fund.

6. The method of claim 4 wherein each particular dealer holding one or more of the financial instruments is entitled to receive an amount of the revenues based on the collective commercial success of all the assets sold by the commercialized by the fund.

7. The method of claim 4 wherein each particular dealer holding one or more of the financial instruments is entitled to receive an amount of the revenues based on the commercial success of assets sold by the particular dealer to the fund.

8. The method of claim 4 wherein each particular dealer holding one or more of the financial instruments is entitled to receive an amount of the revenues based on the comparative commercial success of assets sold by the particular dealer to the fund compared with the commercial success of assets sold by other dealers to the fund.

9. The method of claim 4 wherein the financial instruments issued to the investors entitle the investors to liquidation preferences when the assets are sold by the fund.

10. The method of claim 4 wherein the fund is a limited partnership.

11. The method of claim 4 wherein a committee selects the assets to be purchased from among assets offered by the dealers.

12. The method of claim 4 wherein each of the financial instruments confers a right to receive a share of the revenues of a limited partnership.

13. The method of any one of claims 4 through 12 wherein the assets are works of art.

14. The method of claim 4 wherein the respective portions of the revenues are distributed electronically among the dealers and investors.

15. The method of claim 4 including automated transfer of the respective portions of the revenues among the dealers and investors.

16. A system for distributing revenues in connection with assets comprising:
a first database storing information about each of a plurality of dealers and about one or more assets sold respectively by the dealers to a fund;
a second database storing information about financial instruments issued to each of the dealers in exchange for the assets they sold respectively to the fund, and storing information about financial instruments issued respectively to investors in exchange for their financial investment in the fund;
a third database storing information about revenues obtained on behalf of the fund through commercialization of the assets in the fund; and
a processor coupled to the databases, wherein the processor is adapted to cause the distribution of respective portions of the revenues among the dealers and investors in the fund according to interests in the financial instruments held by the dealers and investors,
wherein a particular investor holding one or more of the financial instruments is entitled to receive an amount of the revenues based on the collective commercial success of all the assets commercialized by the fund; and
wherein a particular dealer holding one or more of the financial instruments is entitled to receive an amount of the revenues based on one or more of the following:
(i) the collective commercial success of all the assets sold by the commercialized by the fund;
(ii) the commercial success of assets sold by the particular dealer to the fund; and
(iii) the comparative commercial success of assets sold by the particular dealer to the fund compared with the commercial success of assets sold by other dealers to the fund.

17. The system of claim 16 wherein at least one of the databases stores information indicative of respective amounts of immediate income that each particular dealer foregoes and to which the particular dealer would otherwise have been entitled upon sale of the one or more assets to the fund based on market value.

18. The system of claim 16 wherein the financial instruments issued to the investors entitle the investors to liquidation preferences when the assets are sold by the fund.

19. The system of claim 16 wherein the assets comprise works of art.

20. The system of claim 16 wherein the assets comprise visual works of art.

21. The system of claim 16 including means for electronically distributing the respective amounts of the revenues among the dealers and investors.

22. The system of claim 16 including means for providing automated transfer of the respective amounts of the revenues among the dealers and investors.
